(19) United States
(12) Patent Application Publication
(10) Pub. No.: US 2024/0001438 A1
(43) Pub. Date: Jan. 4, 2024

(54) AMORPHOUS NANOCRYSTALLINE ALLOY STRIP AND METHOD FOR MANUFACTURING SAME

(71) Applicants: AT&M AMORPHOUS TECHNOLOGY CO., LTD., Beijing (CN); ADVANCED TECHNOLOGY & MATERIALS CO., LTD., Beijing (CN)

(72) Inventors: Wenzhi CHEN, Beijing (CN); Guodong LIU, Beijing (CN); Baisong LI, Beijing (CN); Yang SHI, Beijing (CN); Zhigang LI, Beijing (CN)

(21) Appl. No.: 18/250,553

(22) PCT Filed: Mar. 16, 2021
(86) PCT No.: PCT/CN2021/080903

§ 371 Date: Apr. 26, 2023

(30) Foreign Application Priority Data
Oct. 27, 2020 (CN) 202011160192.4

(51) Int. Cl. B22D 11/06; B22D 11/22

(52) U.S. Cl. CPC B22D 11/0611; B22D 11/0642; B22D 11/0682; B22D 11/22

(57) ABSTRACT

Disclosed is an amorphous nanocrystalline alloy strip. When the amorphous nanocrystalline alloy strip is cut into a plurality of narrow strips having a same width of less than or equal to 10 mm, a relative length difference among the plurality of narrow strips is not greater than 0.50%. Further disclosed is a method for manufacturing the amorphous nanocrystalline alloy strip. The amorphous nanocrystalline alloy strip has good surface flatness. The transverse temperature non-uniformity of molten steel inside a melting pool and the surface temperature non-uniformity of a cooling roller within a strip manufacturing position range are controlled in a process of manufacturing the amorphous nanocrystalline alloy strip, so that the surface flatness of the manufactured strip is improved. The manufacturing process is simple and convenient.

### FIELD OF TECHNOLOGY

The present invention belongs to the field of alloy strips, and particularly relates to an amorphous nanocrystalline alloy strip and a method for manufacturing the same.

### BACKGROUND

An amorphous nanocrystalline alloy is a kind of soft magnetic material developed rapidly in recent years, and has higher magnetic permeability and lower alternating current loss compared with conventional soft magnetic materials such as electrotechnical steel and ferrite, thereby having been widely applied to iron cores of magnetic components such as transformers, inductors, mutual inductors, and motor stators. When used for components such as transformers, inductors, mutual inductors, and motor stators, amorphous nanocrystalline alloy strips with a thickness of only about 0.025 mm are generally wound or stacked into iron cores.

An amorphous nanocrystalline strip is generally manufactured by using a planar flow technology. A manufacturing method includes: melting a certain proportion of raw materials into molten steel by using a smelting furnace; then, pouring the molten steel into a nozzle package with a slit nozzle at a bottom; enabling the molten steel in the nozzle package to flow out of the nozzle and spread on an outer circumferential surface of a copper alloy cooling roller that rotates at a high speed below the nozzle, and forming a molten steel melting pool with a certain size between a surface of the cooling roller and a bottom surface of the nozzle; rapidly pulling out and cooling the molten steel; and continuously replenishing the molten steel in a slit of the nozzle into the melting pool, thus forming a continuous thin strip with an amorphous or nanocrystalline structure.

The amorphous nanocrystalline strip manufactured by the planar flow technology generally has surface roughness to a certain degree, that is, if a section of strip is freely and flatly placed on a horizontal plane, a surface of the strip has wavy fluctuations and is not an ideal flat plane. If the strip is directly used to manufacture an iron core, such surface fluctuations of the strip will reduce a lamination factor of the iron core. If the strip is longitudinally cut, narrow strips at different transverse positions after cutting will have different lengths, which will affect the winding quality of the narrow strips after cutting, and are prone to breakage, uneven winding, and even collapse. Therefore, the amorphous nanocrystalline strip is required to have surface flatness as good as possible, that is, surface roughness as small as possible.

Japanese patent application JP1986226909A discloses a method for manufacturing an iron core from an amorphous strip with surface roughness, that is, the strip is cut into a plurality of narrow strips, and then the narrow strips are wound into the iron core, so that the problem of the loose iron core caused by the uneven strip is avoided.

Chinese patent application CN110998758A provides a method for eliminating surface roughness of an amorphous strip, that is, a certain tension is applied to the amorphous strip with the surface roughness and annealing is performed at a high temperature, to make the surface flat.

In the prior art, the surface roughness of the amorphous strip has been found and is eliminated or alleviated by subsequent treatment. However, processing procedures are added due to such subsequent treatment of the amorphous strip. Therefore, providing an amorphous nanocrystalline alloy strip with good surface flatness is very beneficial to reduce the subsequent processing cost of an iron core and improve the quality of deeply processed products such as the iron core, and is urgently needed.

### SUMMARY

In view of the above problems, the present invention provides an amorphous nanocrystalline alloy strip and a method for manufacturing the same.

There is provided an amorphous nanocrystalline alloy strip. When the amorphous nanocrystalline alloy strip is cut into a plurality of narrow strips having a same width of less than or equal to 10 mm, a relative length difference among the plurality of narrow strips is not greater than 0.50%.

Further, when the amorphous nanocrystalline alloy strip is cut into the plurality of narrow strips having the same width of less than or equal to 10 mm, the relative length difference among the plurality of narrow strips is not greater than 0.20%, and the width of the narrow strips is less than or equal to 10 mm.

Further, when the amorphous nanocrystalline alloy strip is cut into the plurality of narrow strips having the same width of less than or equal to 10 mm, the relative length difference among the plurality of narrow strips is not greater than 0.10%, and the width of the narrow strips is less than or equal to 10 mm.

Further, when the amorphous nanocrystalline alloy strip is cut into the plurality of narrow strips having the same width of less than or equal to 10 mm, the relative length difference among the plurality of narrow strips is not greater than 0.05%, and the width of the narrow strips is less than or equal to 10 mm.

Further, when the amorphous nanocrystalline alloy strip is cut into the plurality of narrow strips having the same width of less than or equal to 10 mm, the relative length difference among the plurality of narrow strips is not greater than 0.02%, and the width of the narrow strips is less than or equal to 10 mm.

A method for manufacturing the above amorphous nanocrystalline alloy strip, including:
melting raw materials into molten steel;
pouring the molten steel into a nozzle package with a nozzle at a bottom;
enabling the molten steel to flow out of the nozzle and spread on an outer circumferential surface of a cooling roller that rotates at a high speed below the nozzle, and forming a melting pool containing the molten steel between a surface of the cooling roller and a bottom surface of the nozzle;
controlling the transverse temperature non-uniformity of the molten steel inside the melting pool to be not greater than 40° C., and/or controlling the surface temperature non-uniformity of the cooling roller before entering the melting pool within a strip manufacturing position range to be not greater than 40° C.; and
rapidly pulling out and cooling the molten steel by the cooling roller to form the amorphous nanocrystalline alloy strip with good surface flatness.

Further, the transverse temperature non-uniformity of the molten steel inside the melting pool is not greater than 20° C.; and the surface temperature non-uniformity of the cooling roller within the strip manufacturing position range is not greater than 20° C.

Further, the controlling the transverse temperature non-uniformity of the molten steel inside the melting pool includes:
blowing a flame or high-temperature gas to a lower-temperature region of the melting pool.

Further, the flame or high-temperature gas is blown to an upstream side or a downstream side of the melting pool.

Further, the controlling the transverse temperature non-uniformity of the molten steel inside the melting pool includes:
blowing a flame or high-temperature gas to a lower-temperature region of the nozzle.

Further, the flame or high-temperature gas is blown to an upstream side or a downstream side of the nozzle.

Further, the controlling the surface temperature non-uniformity of the cooling roller before entering the melting pool within a strip manufacturing position range includes: blowing a flame or high-temperature gas to a lower-temperature region of a roller surface, on an upstream side of the melting pool, of the cooling roller within the strip manufacturing position range.

The amorphous nanocrystalline alloy strip in the present invention has good surface flatness. The transverse temperature non-uniformity of molten steel inside the melting pool and the surface temperature non-uniformity of the cooling roller within the strip manufacturing position range are controlled in the process of manufacturing the amorphous nanocrystalline alloy strip, so that the surface flatness of the manufactured strip is improved. The manufacturing process is simple and convenient. Other features and advantages of the present invention will be described in the following specification, and will become apparent in part from the specification, or will be understood by implementing the present invention. The objective and other advantages of the present invention may be achieved and obtained through the structures indicated in the specification, the claims, and the accompanying drawings.

### BRIEF DESCRIPTION OF THE DRAWINGS

To more clearly illustrate the technical solutions in the embodiments of the present invention or in the prior art, the accompanying drawings that need to be used in the description of the embodiments or the prior art will be briefly described below. Apparently, the accompanying drawings in the description below merely illustrate some embodiments of the present invention. Those of ordinary skill in the art may also derive other accompanying drawings from these accompanying drawings without creative efforts.

FIG. 1 shows a manufacturing principle of manufacturing a strip according to an existing planar flow technology;

FIG. 2 shows a shape of a strip manufactured according to an existing planar flow technology;

FIG. 3 shows a schematic diagram of a length difference among all narrow strips obtained by cutting a section of strip;

FIG. 4 shows a schematic structural diagram of blowing a flame or high-temperature gas to a lower-temperature region of a melting pool or a nozzle according to an embodiment of the present invention; and

FIG. 5 shows a schematic structural diagram of blowing a flame or high-temperature gas to a roller surface, on an upstream side of a melting pool, of a cooling roller within a strip manufacturing position range according to an embodiment of the present invention.

Description of the drawings: 1. nozzle package; 2. cooling roller; 3. strip; 4. surface fluctuation; 5. first flame or high-temperature gas; 6. nozzle; and 7. second flame or high-temperature gas.

### DETAILED DESCRIPTION OF THE EMBODIMENTS

To make the objectives, technical solutions and advantages of the embodiments of the present invention clearer, the technical solutions in the embodiments of the present invention will be clearly and completely described below with reference to the accompanying drawings in the embodiments of the present invention. Apparently, the described embodiments are a part rather than all of the embodiments of the present invention. All other embodiments obtained by those of ordinary skill in the art based on the embodiments of the present invention without creative efforts shall fall within the scope of protection of the present invention.

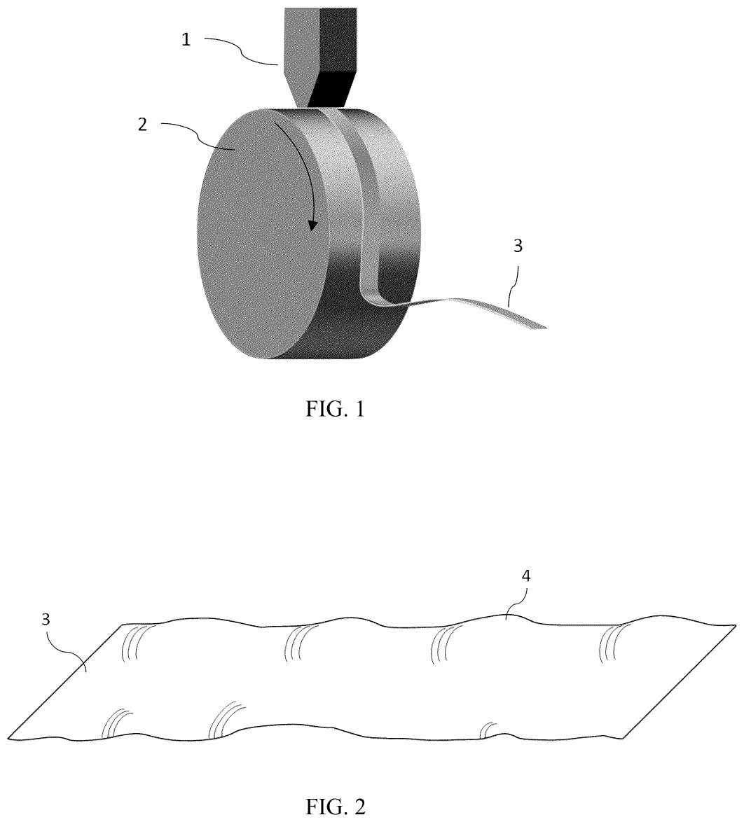

At present, an amorphous nanocrystalline alloy strip used as a soft magnetic material is generally manufactured by using a planar flow technology, and a manufacturing principle thereof is as shown in FIG. 1. A specific technological process includes: melting a certain proportion of raw materials into molten steel by using a smelting furnace; then, pouring the molten steel into a nozzle package 1 with a nozzle 6 at a bottom, where the nozzle 6 is a slit nozzle; enabling the molten steel in the nozzle package 1 to flow out of the nozzle 6 and spread on an outer circumferential surface of a copper alloy cooling roller 2 that rotates at a high speed below the nozzle 6, and forming a molten steel melting pool with a certain size between a surface of the cooling roller 2 and a bottom surface of the nozzle 6; rapidly pulling out and cooling the molten steel; and continuously replenishing the molten steel in a slit of the nozzle 6 into the melting pool, thus forming a continuous thin strip 3 with an amorphous or nanocrystalline structure. Generally, the manufactured amorphous nanocrystalline strip has a width of less than 300 mm and a thickness between 14 μm and 35 μm. Then, the strip is processed into finished products in various shapes by means of winding, stacking, bonding, or cutting.

The amorphous nanocrystalline strip manufactured by using the planar flow technology usually has certain surface roughness. When a free surface of a section of strip 3 is placed on a horizontal plane upwards and is in a free state, there will be periodic longitudinal wavy surface fluctuations 4 in some regions of the strip 3, as shown in FIG. 2. Such surface fluctuations 4 may appear on an edge of the strip or appear in a middle region of the width of the strip 3 or in a transverse position region deviating from the middle of the strip; and such surface fluctuations may appear only in a certain transverse region of the strip 3 or appear in different transverse positions of the strip.

In the present invention, a transverse direction is defined as a width direction of the strip 3; and a longitudinal direction is defined as a length direction of the strip 3, that is, a casting direction of the strip 3.

For an iron and steel plate with wavy fluctuations, a ratio of a height of high points of the wave fluctuations to a distance (i.e. a wavelength) between two adjacent high points may serve as an index to measure the flatness. However, because the amorphous nanocrystalline strip is usually very soft, when the strip is moved, the wavy fluctuations on the strip will change, resulting in larger inconsistency of results of measurement for multiple times. Therefore, such method is not suitable for evaluation of the flatness of the amorphous nanocrystalline strip.

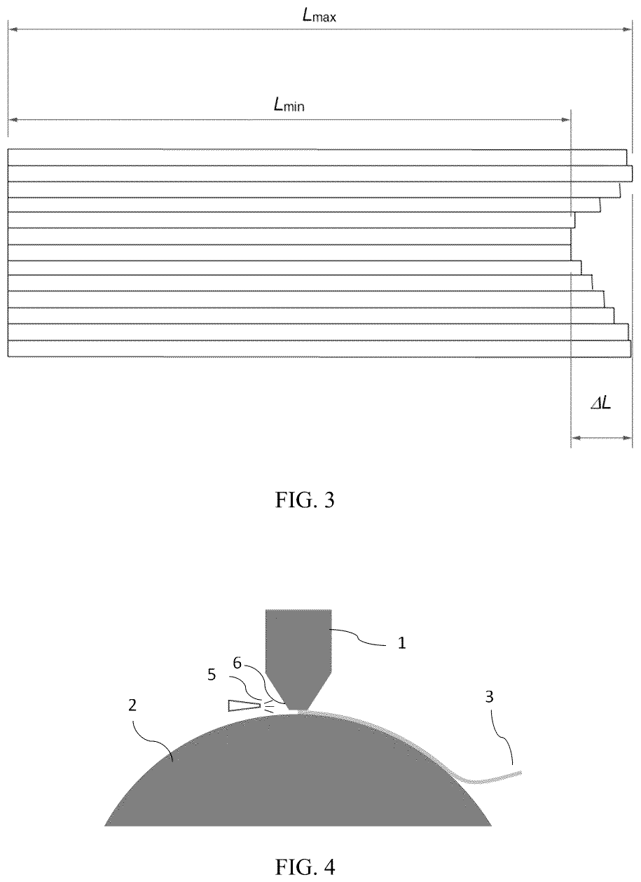

For the soft amorphous nanocrystalline strip with the wavy fluctuations, a relative length difference may be used to evaluate its flatness. For the amorphous nanocrystalline strip with the wavy fluctuations, actual longitudinal lengths of different transverse positions thereof are different. For example, if a section of strip with two neat and parallel longitudinal ends is subjected to longitudinal cutting (also known as longitudinal shearing, slitting, or roller shearing) to form narrow strips with a width of 10 mm or less, the narrow strips after cutting will have different lengths, where regions with wavy fluctuations are longer after cutting, as shown in FIG. 3. The relative length difference of the amorphous nanocrystalline strip may be defined as follows: a section of wide strip is taken, two ends of the strip in the longitudinal direction (the length direction) are cut neatly, and the cut edges are enabled to be perpendicular to the longitudinal direction of the strip; and after the section of wide strip is cut into narrow strips with a width of 10 mm or less along the longitudinal direction, an extreme length difference among all the narrow strips is divided by a length of a shortest narrow strip to obtain a value that is called the relative length difference:

$$δ = \frac{Δ L}{{L}_{min}} \times 100 \% = \frac{{L}_{max} - {L}_{min}}{{L}_{min}} \times 100 \% \qquad ( 1 )$$

where δ is the relative length difference after the narrow strips are obtained by cutting, Δ L is the extreme length difference among all the narrow strips, Lₘₐₓ is a length of a longest narrow strip after cutting of the strip, and Lₘᵢₙ is the length of the shortest strip after cutting of the strip.

The above relative length difference may also be measured and calculated by using a non-contact method without the cutting process. For example, a section of strip freely placed on the horizontal plane is subjected to surface scanning by using a laser ranging device, to obtain a three-dimensional image of the surface fluctuations of the strip, and then the longitudinal lengths of the different transverse positions of the strip are calculated by using software, thus calculating the relative length difference.

According to a calculation formula of the above relative length difference, the present invention relates to an amorphous nanocrystalline alloy strip with good surface flatness. After the amorphous nanocrystalline alloy strip in the present invention is cut into the narrow strips having the width of 10 mm or less, the relative length difference among all the narrow strips is not greater than 0.50%.

Preferably, after the amorphous nanocrystalline alloy strip in the present invention is cut into the narrow strips having the width of 10 mm or less, the relative length difference among all the narrow strips is not greater than 0.20%.

Further, after the amorphous nanocrystalline alloy strip in the present invention is cut into the narrow strips having the width of 10 mm or less, the relative length difference among all the narrow strips is not greater than 0.10%.

More preferably, after the amorphous nanocrystalline alloy strip in the present invention is cut into the narrow strips having the width of 10 mm or less, the relative length difference among all the narrow strips is not greater than 0.05%.

Furthermore, after the amorphous nanocrystalline alloy strip in the present invention is cut into the narrow strips having the width of 10 mm or less, the relative length difference among all the narrow strips is not greater than 0.02%.

According to the fact that the relative length difference among all the narrow strips is not greater than 0.50%, the amorphous nanocrystalline alloy strip in the present invention has better surface flatness and fewer surface fluctuations, and can basically achieve overall surface flatness. An iron core processed by winding or stacking the amorphous nanocrystalline alloy strip in the present invention has a smaller size and a higher lamination factor.

The amorphous nanocrystalline alloy strip with good surface flatness has a width ranging from 50 mm to 300 mm and a thickness ranging from 10 μm to 50 μm.

To obtain the amorphous nanocrystalline alloy strip with good surface flatness, the present invention further provides a method for manufacturing the above amorphous nanocrystalline alloy strip, including:
melting raw materials into molten steel;
pouring the molten steel into a nozzle package 1 with a nozzle 6 at a bottom;
enabling the molten steel to flow out of the nozzle 6 and spread on an outer circumferential surface of a cooling roller 2 that rotates at a high speed below the nozzle 6, and forming a melting pool containing the molten steel between a surface of the cooling roller 2 and a bottom surface of the nozzle 6;
controlling the transverse temperature non-uniformity of the molten steel inside the melting pool to be not greater than 40° C., and/or controlling the surface temperature non-uniformity of the cooling roller 2 before entering the melting pool within a strip manufacturing position range to be not greater than 40° C.; and
rapidly pulling out and cooling the molten steel by the cooling roller 2 to form the amorphous nanocrystalline alloy strip with good surface flatness.

Furthermore, the transverse temperature non-uniformity of the molten steel inside the melting pool is not greater than 20° C.; and
the surface temperature non-uniformity of the cooling roller within the strip manufacturing position range is not greater than 20° C.

To control the transverse temperature non-uniformity of the molten steel inside the melting pool, as shown in FIG. 4, a first flame or high-temperature gas 5 may be blown to a lower-temperature region of the melting pool.

Specifically, the first flame or high-temperature gas 5 is blown to an upstream side or a downstream side of the melting pool.

The first flame or high-temperature gas 5 may also be blown to a lower-temperature region of the nozzle 6.

Specifically, the first flame or high-temperature gas 5 is blown to an upstream side or a downstream side of the nozzle 6.

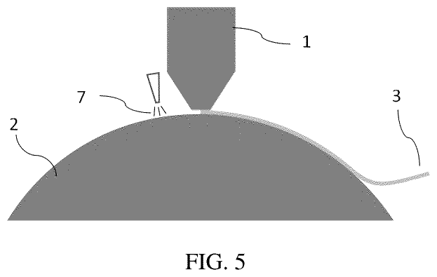

To control the surface temperature non-uniformity of the cooling roller 2 within the strip manufacturing position range, as shown in FIG. 5, a second flame or high-temperature gas 7 is blown to a lower-temperature region of a roller surface, on the upstream side of the melting pool, of the cooling roller 2 within the strip manufacturing position range.

The flame used may be formed by combustion of a combustible gas. If the whole nozzle 6, the whole melting pool or the cooling roller 2 is heated, flow of the first flame or high-temperature gas 5 or the second flame or high-temperature gas 7 in different regions may be adjusted, to adjust a local temperature.

To further illustrate the method for manufacturing the amorphous nanocrystalline strip in the present invention, a plurality of examples and comparative examples are set.

In the examples and comparative examples of Table 1, molten master alloy steel is smelted by using a medium-frequency induction furnace, and optimal parameters such as a temperature, a pressure, and a linear velocity of the cooling roller in the manufacturing process are adjusted by using a planar flow technology to manufacture an amorphous nanocrystalline alloy strip with a width ranging from 50 mm to 284 mm and an average thickness ranging from 18 μm to 35 μm. The composition, critical process parameters and strip size of the manufactured strip are listed in Table 1.

TABLE 1

| | | | Linear | | | Static | | |
|---|---|---|---|---|---|---|---|---|
| | | Temperature | surface | Width | | pressure | | |
| | | (° C.) of | velocity | (mm) | Roller- | (kPa) of | | Average |
| | Nominal | molten | (m/s) of | of slit | nozzle | molten | Strip | strip |
| | composition | steel at | cooling | of | distance | steel at | width | thickness |
| | (at %) | nozzle | roller | nozzle | (mm) | nozzle | (mm) | (μm) |
| Example 1 | Fe₇₉Si₉B₁₂ | 1380 | 22 | 0.38 | 0.30 | 35 | 142 | 25 |
| Example 2 | Fe₈₂Si₄B₁₃C₁ | 1370 | 20 | 0.42 | 0.27 | 38 | 284 | 28 |
| Example 3 | Fe₈₃Si₃B₁₁C₁P₂ | 1370 | 22 | 0.40 | 0.28 | 38 | 170 | 29 |
| Example 4 | Fe_{73.5}Cu₁Nb₃Si_{13.5}B₉ | 1410 | 25 | 0.25 | 0.25 | 30 | 80 | 15 |
| Example 5 | Fe_{73.5}Cu₁Nb₃Si_{13.5}B₉ | 1410 | 25 | 0.30 | 0.25 | 30 | 80 | 19 |
| Example 6 | Co₆₆Fe₄Mn₂V₂Si₈B₁₈ | 1370 | 20 | 0.40 | 0.30 | 40 | 60 | 34 |
| Comparative | Fe₈₂Si₄B₁₃C₁ | 1370 | 20 | 0.42 | 0.27 | 38 | 284 | 28 |
| example 1 | | | | | | | | |
| Comparative | Fe_{73.5}Cu₁Nb₃Si_{13.5}B₉ | 1410 | 25 | 0.30 | 0.25 | 30 | 80 | 15 |
| example 2 | | | | | | | | |

During the process of manufacturing the strip in the above examples and comparative examples, it is ensured that the process parameters in Table 1 remain unchanged, and a transverse temperature distribution of the molten steel inside the melting pool is measured by using a bicolorimetric infrared thermometer in a transverse continuous scanning mode or by using a thermal imager. The first flame or high-temperature gas is continuously blown to the upstream side and/or the downstream side of the nozzle 6 in the lower-temperature region, so that a temperature difference between a temperature of the molten steel in the region and a temperature in a high-temperature region is kept within 40° C.

Meanwhile, a temperature distribution of the surface, on the upstream side of the melting pool, of the cooling roller 2 within the strip manufacturing position range is measured by using the bicolorimetric infrared thermometer in the transverse continuous scanning mode or by using the thermal imager. The second flame or high-temperature gas 7 is continuously blown to the lower-temperature region of the roller surface on the upstream side of the melting pool, so that a temperature difference between a temperature of the roller surface in the region and the temperature in the high-temperature region is kept within 40° C.

Through the control of the transverse temperature non-uniformity of the molten steel inside the melting pool and the surface temperature non-uniformity of the cooling roller 2 within the strip manufacturing position range, after other parameters remain unchanged and the amorphous nanocrystalline strip is manufactured, a strip sample with a length of more than one meter is taken for each heat. The strip sample is longitudinally cut into ten narrow strips with a width of 10 mm, a length of each narrow strip is measured, and then a relative length difference is calculated with a formula (1). The roughness and relative length difference of the obtained strip are as shown in Table 2:

TABLE 2

| | Initial | | | | Improved | | |
|---|---|---|---|---|---|---|---|
| | temperature | | Measures to | | temperature | | |
| | non- | Initial | improve | Measures | non- | Improved | |
| | uniformity | temperature | temperature | to improve | uniformity | temperature | |
| | (° C.) of | non- | non- | temperature | (° C.) of | non- | |
| | molten | uniformity | uniformity of | non- | molten | uniformity | Relative |
| | steel in | (° C.) of | molten steel | uniformity | steel in | (° C.) of | length |
| | melting | roller | in melting | of roller | melting | roller | difference |
| | pool | surface | pool | surface | pool | surface | of strip |
| Example 1 | 20 | 41 | — | Blow | — | 31 | 0.38% |
| | | | | flame to | | | |
| | | | | local part | | | |
| | | | | of roller | | | |
| | | | | surface | | | |
| Example 2 | 58 | 46 | Blow flame | Blow | 15 | 18 | 0.19% |
| | | | to local part | flame to | | | |
| | | | of nozzle | local part | | | |
| | | | | of roller | | | |
| | | | | surface | | | |
| Example 3 | 45 | 42 | Blow flame | Blow | 32 | 35 | 0.29% |
| | | | to local part | flame to | | | |
| | | | of nozzle | local part | | | |
| | | | | of roller | | | |
| | | | | surface | | | |
| Example 4 | 44 | 42 | Blow flame | Blow high- | 20 | 18 | 0.15% |
| | | | to local part | temperature | | | |
| | | | of nozzle | gas to | | | |
| | | | | local part | | | |
| | | | | of roller | | | |
| | | | | surface | | | |
| Example 5 | 41 | 42 | Blow flame | Blow high- | 9 | 8 | 0.015% |
| | | | to local part | temperature | | | |
| | | | of nozzle | gas to | | | |
| | | | | local part | | | |
| | | | | of roller | | | |
| | | | | surface | | | |
| Example 6 | 42 | 18 | Blow flame | — | 12 | — | 0.098% |
| | | | to local part | | | | |
| | | | of nozzle | | | | |
| Comparative | 58 | 46 | — | — | — | — | 0.83% |
| example 1 | | | | | | | |
| Comparative | 44 | 42 | — | — | — | — | 0.61% |
| example 2 | | | | | | | |

It may be seen from Table 2 that when the transverse temperature non-uniformity of the molten steel inside the melting pool is not greater than 40° C. and the temperature non-uniformity of the surface, on the upstream side of the melting pool, of the cooling roller 2 within the strip manufacturing position range is not greater than 40° C., the relative length difference of the strip is less than 0.50%. If the temperature non-uniformity of the melting pool and the roller surface after start of strip manufacturing exceeds a specified range, the roughness and relative length difference of the strip will be greater than the range in the present invention; and after the nozzle 6 and the roller surface are locally blown with the flame and/or high-temperature gas, the temperature non-uniformity of the melting pool and the roller surface may be controlled to be within the specified range. At this time, the roughness and relative length difference of the strip are controlled to be within the range in the present invention again. That is, the amorphous nanocrystalline strip with good flatness can be manufactured by the method for manufacturing the amorphous nanocrystalline strip in the present invention.

To better illustrate the effect that the amorphous nanocrystalline strip in the present invention can effectively improve the lamination factor of the subsequently processed iron core, iron-based amorphous wide strips with a same width (142 mm), a same thickness (0.024 mm), a same shape, the same surface quality and different relative length differences are taken and are wound into annular iron cores with a same size (an inner diameter of 300 mm, and an outer diameter of 450 mm). The lamination factor of the iron core is calculated according to the mass, size and other parameters of the iron core, and results are shown in Table 3. It may be seen that as the relative length difference of the wide strip gradually decreases from 0.80% to 0.07%, the lamination factor of the wound iron core gradually increases from 78% to 85.5%.

TABLE 3

| | Relative length difference of strip | | | | | |
|---|---|---|---|---|---|---|
| | 0.80% | 0.50% | 0.34% | 0.25% | 0.13% | 0.07% |
| Lamination | 78% | 79.7% | 81.1% | 82.4% | 83.9% | 85.5% |
| factor of | | | | | | |
| iron core | | | | | | |

Although the present invention has been described in detail with reference to the above embodiments, those of ordinary skill in the art should understand that they still may modify the technical solutions described in the above embodiments, or equivalently substitute some of the technical features in the technical solutions; and these modifications or substitutions do not make the essences of the corresponding technical solutions depart from the spirit and scope of the technical solutions of the embodiments of the present invention.

What is claimed is:

1. An amorphous nanocrystalline alloy strip, wherein when the amorphous nanocrystalline alloy strip is cut into a plurality of narrow strips having a same width of less than or equal to 10 mm, a relative length difference among the plurality of narrow strips is not greater than 0.50%.

2. The amorphous nanocrystalline alloy strip according to claim 1, wherein when the amorphous nanocrystalline alloy strip is cut into the plurality of narrow strips having the same width of less than or equal to 10 mm, the relative length difference among the plurality of narrow strips is not greater than 0.20%, and the width of the narrow strips is less than or equal to 10 mm.

3. The amorphous nanocrystalline alloy strip according to claim 1, wherein when the amorphous nanocrystalline alloy strip is cut into the plurality of narrow strips having the same width of less than or equal to 10 mm, the relative length difference among the plurality of narrow strips is not greater than 0.10%, and the width of the narrow strips is less than or equal to 10 mm.

4. The amorphous nanocrystalline alloy strip according to claim 1, wherein when the amorphous nanocrystalline alloy strip is cut into the plurality of narrow strips having the same width of less than or equal to 10 mm, the relative length difference among the plurality of narrow strips is not greater than 0.05%, and the width of the narrow strips is less than or equal to 10 mm.

5. The amorphous nanocrystalline alloy strip according to claim 1, wherein when the amorphous nanocrystalline alloy strip is cut into the plurality of narrow strips having the same width of less than or equal to 10 mm, the relative length difference among the plurality of narrow strips is not greater than 0.02%, and the width of the narrow strips is less than or equal to 10 mm.

6. A method for manufacturing the amorphous nanocrystalline alloy strip according to claim 1, comprising:
melting raw materials into molten steel;
pouring the molten steel into a nozzle package with a nozzle at a bottom;
enabling the molten steel to flow out of the nozzle and spread on an outer circumferential surface of a cooling roller that rotates at a high speed below the nozzle, and forming a melting pool containing the molten steel between a surface of the cooling roller and a bottom surface of the nozzle;
controlling the transverse temperature non-uniformity of the molten steel inside the melting pool to be not greater than 40° C., and/or controlling the surface temperature non-uniformity of the cooling roller before entering the melting pool within a strip manufacturing position range to be not greater than 40° C.; and
rapidly pulling out and cooling the molten steel by the cooling roller to form the amorphous nanocrystalline alloy strip with good surface flatness.

7. The method for manufacturing the amorphous nanocrystalline alloy strip according to claim 6, wherein the transverse temperature non-uniformity of the molten steel inside the melting pool is not greater than 20° C.; and
the surface temperature non-uniformity of the cooling roller within the strip manufacturing position range is not greater than 20° C.

8. The method for manufacturing the amorphous nanocrystalline alloy strip according to claim 6, wherein the controlling the transverse temperature non-uniformity of the molten steel inside the melting pool comprises:
blowing a flame or high-temperature gas to a lower-temperature region of the melting pool.

9. The method for manufacturing the amorphous nanocrystalline alloy strip according to claim 8, wherein the flame or high-temperature gas is blown to an upstream side or a downstream side of the melting pool.

10. The method for manufacturing the amorphous nanocrystalline alloy strip according to claim 6, wherein the controlling the transverse temperature non-uniformity of the molten steel inside the melting pool comprises:
blowing a flame or high-temperature gas to a lower-temperature region of the nozzle.

11. The method for manufacturing the amorphous nanocrystalline alloy strip according to claim 10, wherein the flame or high-temperature gas is blown to an upstream side or a downstream side of the nozzle.

12. The method for manufacturing the amorphous nanocrystalline alloy strip according to claim 6, wherein the controlling the surface temperature non-uniformity of the cooling roller before entering the melting pool within a strip manufacturing position range comprises: blowing a flame or high-temperature gas to a lower-temperature region of a roller surface, on an upstream side of the melting pool, of the cooling roller within the strip manufacturing position range.
